(19) United States
(12) Patent Application Publication
(10) Pub. No.: US 2014/0306903 A1
(43) Pub. Date: Oct. 16, 2014

(54) METHODS OF EVALUATING TOUCH PROCESING

(71) Applicant: QUALCOMM Incorporated, San Diego, CA (US)

(72) Inventors: William Yee-Ming HUANG, Vista, CA (US); Mohamed Imtiaz AHMED, San Marcos, CA (US); Raghukul TILAK, San Diego, CA (US); Suhail JALIL, Poway, CA (US); Khosro Mohammad RABII, San Diego, CA (US)

(73) Assignee: QUALCOMM Incorporated, San Diego, CA (US)

(21) Appl. No.: 14/223,818

(22) Filed: Mar. 24, 2014

Related U.S. Application Data
(60) Provisional application No. 61/812,201, filed on Apr. 15, 2013.

(51) Int. Cl. G06F 3/041

(52) U.S. Cl. CPC G06F 3/041
USPC 345/173

(57) ABSTRACT

A touchscreen system includes a touchscreen configured to receive touch data from a user, a plurality of modules, and a touch performance profiler module communicatively coupled to at least one of the plurality of modules. The plurality of modules are collectively configured to process the touch data and display an output based on the processed touch data. The touch performance profiler module is configured to monitor the at least one of the plurality of modules in real-time and output performance attributes of the at least one of the plurality of modules based at least in part on the monitoring.

### CROSS REFERENCE TO RELATED APPLICATIONS

This application claims the benefit of U.S. Provisional Application No. 61/812,201, filed Apr. 15, 2013 and titled “METHODS FOR EVALUATING TOUCH PROCESSING”, the disclosures of which are incorporated herein by reference in their entirety and for all purposes.

### BACKGROUND

The present disclosure relates generally to a touch device, and more particularly, to methods and apparatuses for evaluating performance attributes of a touchscreen system.

Devices such as computing devices, mobile devices, kiosks, etc. often employ a touch screen interface with which a user can interact with the devices by touch input (e.g., touch by a user or an input tool such as a pen). Touch screen devices employing the touch screen interface provide convenience to users, as the users can directly interact with the touch screen. The touch screen devices receive the touch input, and execute various operations based on the touch input. For example, a user may touch an icon displayed on the touch screen to execute a software application associated with the icon, or a user may draw on the touch screen to create drawings. The user may also drag and drop items on the touch screen or may pan a view on the touch screen with two fingers. Thus, a touch screen device that is capable of accurately analyzing the touch input on the touch screen is needed to accurately execute desired operations. Methods for testing the performance of touch detection algorithms or apparatuses are desired, therefore, in order to determine which algorithms or apparatuses perform better.

### BRIEF SUMMARY

In some embodiments, a touchscreen system includes a touchscreen configured to receive touch data from a user. The touchscreen system also includes a plurality of modules collectively configured to process the touch data and display an output based on the processed touch data. The touchscreen system further includes a touch performance profiler module communicatively coupled to at least one of the plurality of modules and configured to monitor the at least one of the plurality of modules in real-time and output performance attributes of the least one of the plurality of modules based at least in part on the monitoring.

In some embodiments, the output performance attributes include data indicative of scan-rate of the touchscreen, power consumption of the touchscreen system, latency of the touchscreen system, linearity error, stability, or accuracy of the touchscreen.

In some embodiments, the touchscreen system is communicatively coupled to a display device configured to present the performance attributes to a user.

In some embodiments, the touch performance profiler module resides within a kernel layer of an operating system.

In some embodiments, the touch performance profiler module is further configured to analyze the performance attributes of the at least one of the plurality of modules based at least in part on the monitoring and output results of the analysis of the performance attributes, wherein the results are indicative of performance of the touchscreen system.

In some embodiments, the output performance attributes comprise a pass or fail result for the at least one of the plurality of modules.

In some embodiments, the touch performance profiler module is further configured to simulate one or more real-world variables that affect the performance attributes of the at least one of the plurality of modules.

In some embodiments, the one or more real-world variables comprises at least one of heat, noise, moisture, or brightness.

In some embodiments, a method for evaluating touch processing on a touchscreen system includes receiving touch data representative of a touch on a touchscreen. The method also includes monitoring the performances of a plurality of modules, wherein each module is configured to process the touch data. The method further includes outputting performance data indicative of the performances of the plurality of modules.

In some embodiments, an apparatus for evaluating touch processing on a touchscreen system includes means for receiving touch data representative of a touch on a touchscreen. The apparatus also includes means for monitoring the performances of a plurality of modules, wherein each module is configured to process the touch data. The apparatus further includes means for outputting performance data indicative of the performances of the plurality of modules.

In some embodiments, a processor-readable non-transitory medium comprises processor readable instructions configured to cause a processor to receive touch data representative of a touch on a touchscreen of a touchscreen system, monitor the performances of a plurality of modules, wherein each module is configured to process the touch data, and output performance data indicative of the performances of the plurality of modules.

In some embodiments, a method for evaluating touch detection performance includes receiving at least a first touch data from a touch screen recorded at a first time. The method also includes computing at least one evaluation function using the at least first touch data. The method additionally includes computing at least one metric indicating a measure of performance of the touch screen based on the at least one evaluation function.

In some embodiments, computing the at least one evaluation function includes modeling the at least first touch data as a Hidden Markov Model (HMM), estimating a ground truth identification of the at least first touch data; and computing a curve fit to the at least first touch data.

In some embodiments, computing the at least one metric indicating a measure of performance of the touch screen is based further on the HMM, the estimated ground truth, and the computed curve fit.

In some embodiments, the at least first touch data comprises data from multiple strokes inputted simultaneously on the touch screen.

In some embodiments, the curve fit comprises a second-order binomial curve fit.

In some embodiments, the method also includes receiving a description of the at least first touch data from a user, and wherein computing the curve fit comprises generating a level of complexity of the curve fit based on the received description of the at least first touch data from the user.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a simplified block diagram illustrating a portable device that may incorporate one or more embodiments;

FIG. 2 is a diagram illustrating an example of a mobile touch screen device with a touch screen controller according to some embodiments;

FIG. 3 is a diagram illustrating a touch signal processing architecture including a touch performance profiler module;

FIG. 4 is a diagram illustrating components of the touch performance profiler;

FIG. 5 illustrates a number of performance attributes displayed to a user via a display on a portable device;

FIG. 6 is a flowchart of an exemplary method of evaluating touch processing on a touchscreen system;

FIG. 7 illustrates an example of a computing system in which one or more embodiments may be implemented;

FIG. 8 is a diagram illustrating an example of mobile device architecture with a touch screen display and an external display device according to some embodiments;

FIG. 9 illustrates an example of a capacitive touch processing data path in a touch screen device according to some embodiments;

FIG. 10 illustrates a closer look at display and touch subsystems in mobile-handset architecture according to some embodiments;

FIG. 11 is an example plot of test data on a touch screen used in methods according to some embodiments;

FIGS. 12A & 12B illustrate example Hidden Markov Modeling techniques according to some embodiments;

FIGS. 13A-13D illustrate example curve fit computations according to some embodiments; and

FIG. 14 illustrates an example flowchart according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Several aspects of touch screen devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Touch screen technology enables various types of uses. As discussed supra, a user may touch a touch screen to execute various operations such as execution of an application. In one example, the touch screen provides a user interface with a direct touch such as a virtual-keyboard and user-directed controls. The user interface with the touch screen may provide proximity detection. The user may hand-write on the touch screen. In another example, the touch screen technology may be used for security features, such as surveillance, intrusion detection and authentication, and may be used for a use-environment control such as a lighting control and an appliance control. In another example, the touch screen technology may be used for healthcare applications (e.g., a remote sensing environment, prognosis and diagnosis).

Several types of touch screen technology are available today, with different designs, resolutions, sizes, etc. Examples of the touch screen technology with lower resolution include acoustic pulse recognition (APR), dispersive signal technology (DST), surface acoustic wave (SAW), traditional infrared (IR/NIR), waveguide infrared, optical, and force-sensing. A typical mobile device includes a capacitive touch screen (e.g., mutual projective-capacitance touch screen), which allows for higher resolution and a thin size of the screen. Further, a capacitive touch screen provides good accuracy, good linearity and good response time, as well as relatively low chances of false negatives and false positives. Therefore, the capacitive touch screen is widely used in mobile devices such as mobile phones and tablets. Examples of a capacitive touch screen used in mobile devices include an in-cell touch screen and an on-cell touch screen, which are discussed infra.

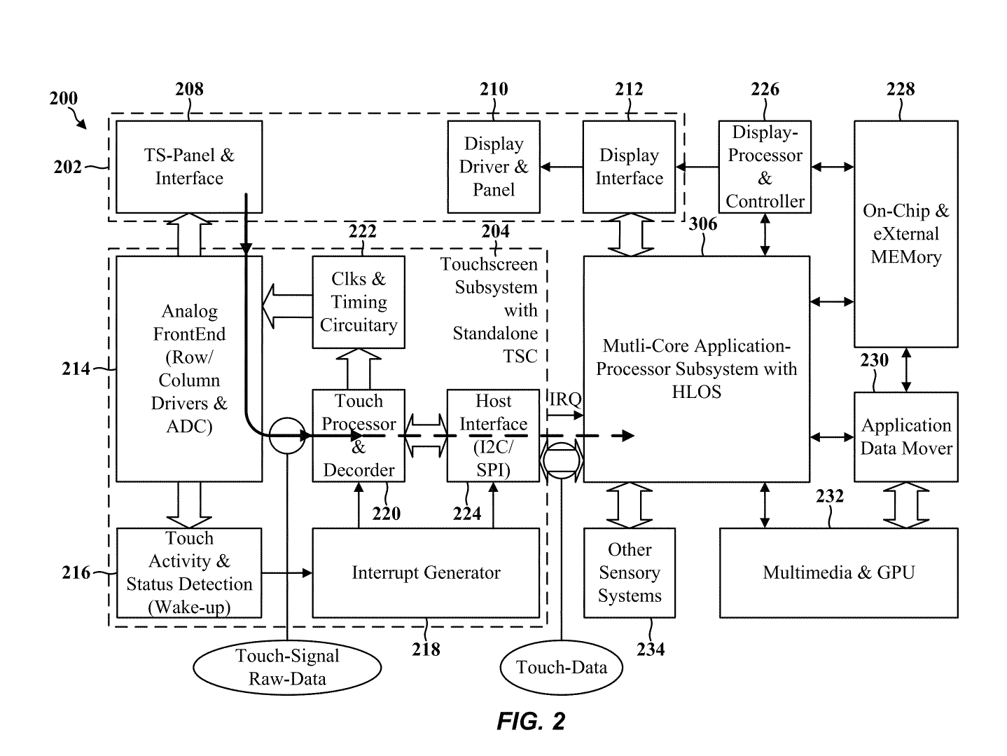

Methods and apparatuses are presented for enabling a customer to evaluate performance attributes of various modules in a touchscreen system. A device with touchscreen capability, such as a smartphone, contains numerous intricate parts that, together, take the literal touch from a user and output some kind of graphic or functional response on the display of the touch screen. FIG. 2 provides an example diagram of the many functional modules that are integrated together to output a touchscreen response based on a user's touch. These functional modules may each require some hardware, software and/or firmware in order to carry out its designated function. In most cases, all of these modules must operate properly in order for the overall touchscreen system to work. This suggests that if one of these parts fails, the entire system could fail, and that the overall performance of the system—where performance could be based on various metrics, including power consumption, latency, jitter, accuracy, etc.—is based on the aggregate performances of each individual module.

In most cases, the user or customer never sees how each of these intricate pans performs individually, and tends to judge the quality of the touchscreen system based on the overall performance only, e.g., the end result of the quality of the touchscreen response. For example, available touchscreen evaluator applications may simply be some software that runs on the application layer that can only evaluate the start-to-finish latency of a touch until when it is converted to a response on the display. If the response is slow, for example, the user may never know what module or modules in the chain of modules (e.g. the modules in FIG. 2 along the path of arrows) are most responsible for the slow response. This suggests that the overall performance of the touchscreen system could be improved, optimized, or simply tweaked to fit a specific need (e.g. more sensitive touch screen for certain applications, less sensitive touch screen for others), if the user or customer has the ability to evaluate the performance of the individual modules that make up the overall touchscreen system, so that faulty or flawed modules could be improved or compensated for.

Currently, many manufacturers of host devices use touchscreen controllers manufactured by third-parties to process touches on the host device. However, touchscreen sensors are getting closer to the display structure on the host device (e.g., on-cell and in-cell touch panel monitors) to minimize costs and reduce thickness of the display panel module. This integration requires that the performance of the touchscreen controller be constantly tuned (in real-time) to the instantaneous performance of the touch panel module. However, most of today's touchscreen controllers are unable to learn the status of the display. Additionally, modern day display types with increased dynamic processing behavior to save power (AMLCD with CABL, AMOLED, etc.) require the touchscreen controller to constantly baseline its processing, thereby increasing the complexity of real-time tuning of the touchscreen controller instantaneous performance to the touch panel module performance.

Moreover, mobile terminals with large displays and multi-touch capabilities strain typical touchscreen controller processing capabilities because they demand increasingly more processing capability and memory from the touchscreen controller built in larger geometries. As a result of the larger die sizes, yields are decreased and costs are increased. Similarly, nearness/proximity detection and the use of stylus devices enable a whole new generation of applications and use-cases for a touchscreen. These new applications and use-cases increasingly require demanding processing capabilities from the underlying infrastructure which exceeds the typical touchscreen controller processing capability and available memory in large geometries.

Additionally, many next generation mobile terminal devices may well exceed today's familiar smartphones, tablet computers, etc. For example, wrist-worn and head-mounted wearable devices are gaining consumer acceptance. These different types of wearable devices may be offered in different forms to support diverse services and features. These devices will require that the touch sensor and underlying processing be customizable to a wearable format. These devices may also be expected to be constantly worn and in-touch with the user. As such, it is critical that the device(s) be in an always-on state to process a multitude of sensor data, most notably touch to enable many essential applications (e.g., health and security applications).

As described above, touch processing is expected to become a core service and host devices need systems and methods to better process real-time raw touch signals to evaluate and enhance touch performance. Such systems and methods may be useful by both manufacturers during the design stage and end users during real-time usage of the touchscreen device.

Apparatuses and methods of the present disclosures enable a customer to make such evaluations on individual modules in a touchscreen system in order to evaluate touch processing performance. In some embodiments, a module, referred to herein as a touch performance profiler, may be installed into a lower level of the touch-processing chain to enable monitoring and evaluation of the many lower level modules of the touchscreen system.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

### Portable Device Including a Capacitive Touch Panel

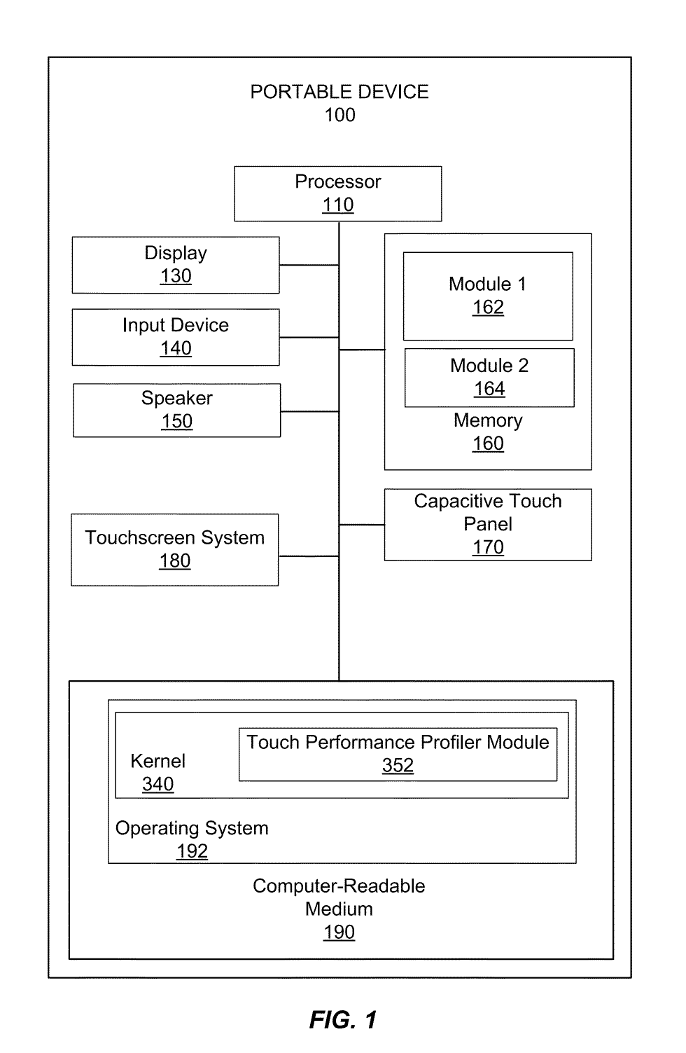

FIG. 1 illustrates a simplified block diagram of a portable device 100 that may incorporate one or more embodiments. Portable device 100 includes a processor 110, display 130, input device 140, speaker 150, memory 160, capacitive touch panel 170, touchscreen system 180, and computer-readable medium 190.

Processor 110 may be any general-purpose processor operable to carry out instructions on the portable device 100. The processor 110 is coupled to other units of the portable device 100 including display 130, input device 140, speaker 150, capacity touch panel 170, touchscreen system 180, and computer-readable medium 190.

Display 130 may be any device that displays information to a user. Examples may include an LCD screen, CRT monitor, or seven-segment display.

Input device 140 may be any device that accepts input from a user. Examples may include a keyboard, keypad, mouse, or touch input.

Speaker 150 may be any device that outputs sound to a user. Examples may include a built-in speaker or any other device that produces sound in response to an electrical audio signal.

Memory 160 may be any magnetic, electronic, or optical memory. Memory 160 includes two memory modules, module 1 162 and module 2 164. It can be appreciated that memory 160 may include any number of memory modules. An example of memory 160 may be dynamic random access memory (DRAM).

The capacitive touch panel 170 and the display 130 may be generally coextensive and form a user interface for the portable device 100. A user may touch the capacitive touch panel 170 to control operation of the portable device 100. In some embodiments, the touch may be made by a single finger of the user or by several fingers. In other embodiments, the touch may be made by other portions of the user's hand or other body parts. In yet other embodiments, the touch may be made by the use of a stylus gripped by the user or otherwise brought into contact with the capacitive touch panel 170. In other applications, the capacitive touch panel 170 may be embodied as a touch pad of the portable device 100. In such an application, the display 130 may not be coextensive with the capacitive touch panel 170 but may be located nearby for viewing by a user who touches the capacitive touch panel 170 to control the computing device.

Touchscreen system 180 can include a touch front end (TEE) and/or touch back end (TBE). This partition is not fixed or rigid, but may vary according to the high-level function(s) that each block performs and that are assigned or considered front end or back end functions. The TEE operates to detect the capacitance of the capacitive sensor that comprises the capacitive touch panel 170 and to deliver a high signal to noise ratio (SNR) capacitive image (or heatmap) to the TBE. The TBE can take this capacitive heatmap from the TEE and discriminate, classify, locate, and track the object(s) touching the capacitive touch panel 170 and report this information back to the processor 110. The TEE and the TBE may be partitioned among hardware and software or firmware components as desired, e.g., according to any particular design requirements. In one embodiment, the TEE may be largely implemented in hardware components and some or all of the functionality of the TBE may be implemented by the processor 110.

Computer-readable medium 190 may be any magnetic, electronic, optical, or other computer-readable storage medium. Computer-readable medium 190 may include one or more software modules executable by processor 110. Computer-readable medium 190 may also include an operating system 192. The operating system 192 may be any operating system capable of being executed by the processor 110 of the portable device 100. In some embodiments, the operating system 192 may be a mobile operating system. The operating system 192 can include kernel 340. The kernel 340 may manage input/output requests for processor 110. The kernel 340 may include touch performance profiler module 352.

Touch performance profiler module 352 may be configured to monitor and analyze performance attributes of a plurality of hardware and/or software modules (not shown) in a touch-processing chain within a touchscreen system 180. In some embodiments, the touch performance profiler module 352 may be installed into a lower level of the touch-processing chain to enable monitoring and evaluation of the many lower level modules of the touchscreen system. The touch performance profiler module 352 may be communicatively coupled to the hardware and/or software modules within the touchscreen system 180. The various hardware and/or software modules in the touch-processing chain may process touch data generated in response to a touch from a user. The various hardware and/or software modules may also display an output based on the processed touch data. The touch performance profiler module 352 may monitor the various hardware and/or software modules, in real-time, while the various modules process the touch data and/or display the output based on the processed touch data. The touch performance profiler module 352 may also output performance attributes of the various modules based on the monitoring. In some embodiments, the touch performance profiler module 352 may simulate various real-world variables for the various modules while monitoring the various modules. For example, the touch performance profiler module 352 may simulate heat, noise, moisture, or brightness that could affect real-world performance of the various hardware and/or software modules in the touch-processing chain.

### Touch Signal Processing Architectures

FIG. 2 is a diagram illustrating an example of a mobile touch screen device 200 with a touch screen controller according to some embodiments. The mobile touch screen device 200 includes a touch screen display unit 202 and a touch screen subsystem with a standalone touch screen controller 204 that are coupled to a multi-gore application-processor subsystem with High Level Output Specification (HLOS) 206. The touch screen display unit 202 includes a touch screen panel and interface unit 208, a display driver and panel unit 210, and a display interface 212. The display interface 212 is coupled to the display driver and panel unit 210 and the multi-core application processor subsystem 206 with HLOS. The touch screen panel and interface unit 208 receives a touch input via a user touch, and the display driver and panel unit 210 displays an image. The touch screen controller 204 includes an analog front end 214, a touch activity and status detection unit 216, an interrupt generator 218, a touch processor and decoder unit 220, clocks and timing circuitry 222, and a host interface 224. The analog front end 214 communicates with the touch screen panel and interface unit 208 to receive an analog touch signal based on a user touch on the touch screen, and may convert the analog touch signal to a digital touch signal to create touch signal raw data. The analog front end 211 may include row/column drivers and an analog-to-digital converter (ADC).

The touch activity and status detection unit 216 receives the touch signal from the analog front end 214 and then communicates to the interrupt generator 218 of the presence of the user touch, such that the interrupt generator 218 communicates a trigger signal to the touch processor and decoder unit 220. When the touch processor and decoder unit 220 receives the trigger signal from the interrupt generator 218, the touch processor and decoder unit 220 receives the touch signal raw data from the analog front end 214 and processes the touch signal raw data to create touch data. The touch processor and decoder unit 220 sends the touch data to the host interface 324, and then the host interface 324 forwards the touch data to the multi-core application processor subsystem 206. The touch processor and decoder unit 220 is also coupled to the clocks and timing circuitry 222 that communicates with the analog front end 214.

In some embodiments, processing of the touch signal raw data is processed in the multi-core application processor subsystem 206 instead of in the decoder unit 220. In some such embodiments, the touch screen controller 204 or one or more components thereof, for example the decoder unit 220, may be omitted. In other such embodiments, the touch screen controller 204 and/or all components thereof are included, but touch signal raw data is passed through to the multi-core application processor subsystem 206 without or with reduced processing. In some embodiments, processing of the touch signal raw data is distributed between the decoder unit 220 and the multi-core application processor subsystem 206.

The mobile touch screen device 200 also includes a display-processor and controller unit 226 that sends information to the display interface 212, and is coupled to the multi-core application processor subsystem 206. The mobile touch screen device 200 further includes an on-chip and external memory 228, an application data mover 230, a multimedia and graphics processing unit (GPU) 232, and other sensor systems 234, which are coupled to the multi-core application processor subsystem 206. The on-chip and external memory 228 is coupled to the display processor and controller unit 226 and the application data mover 230. The application data mover 230 is also coupled to the multimedia and graphics processing unit 232.

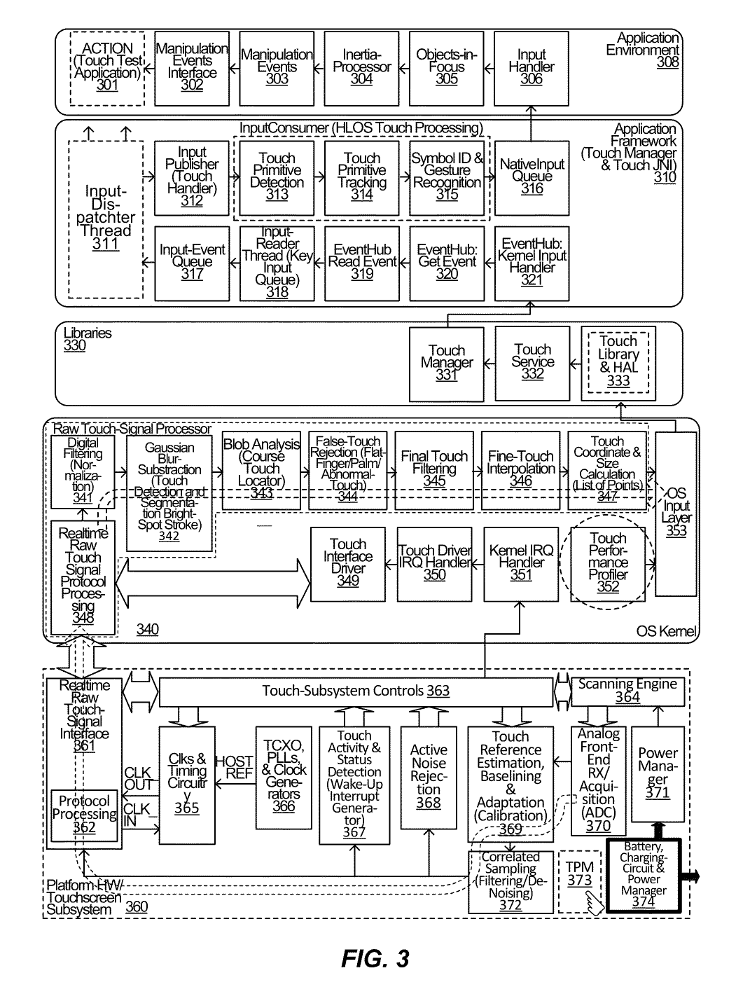

FIG. 3 is a diagram illustrating a touch signal processing architecture 300 including a touch performance profiler module 352. Typical touch-evaluator applications may be implemented at the highest level—the application environment—and possess little to no visibility into any of the various modules or components in the entire touch processing chain. In contrast however, the touch performance profiler module 352 may be implemented at a lower level e.g., in the operating system (OS) kernel 340. The touch performance profiler module 352 may also be configured to monitor readings of various modules near and lower in the touch processing chain in real time. In some embodiments, the touch performance profiler module 352 may be installed as hardware and pre-configured with hardware taps connected to the other modules of the touch signal processing architecture 300 so that the other modules may be properly evaluated. The ability to evaluate individual modules of an overall system may be referred to as “white-box testing” capabilities.

Benefits of the white-box testing functionality according to the present disclosures are numerous. For example, unlike conventional touchscreen evaluation methods, the present disclosures allow for measurement of various touchscreen performance metrics, including scan-rate, power, (while active, idle, or in sleep mode), latency (i.e. time between touch and response of display), linearity error (i.e. how straight the output is based on receiving a line of touch data), and accuracy (i.e. how accurate the output is based on the location of touch data).

The touch signal processing architecture 300 includes several hardware and/or software layers. These layers may include the application environment layer 308, application framework layer 310, touch libraries 330, OS kernel layer 340, and platform hardware/touchscreen subsystem layer 360.

The platform hardware/touchscreen subsystem layer 360 includes a real-time raw touch-signal interface 361 coupled to touch-subsystem controls unit 363. The real-time raw touch-signal interface 361 also includes a protocol processing unit 362. The touch-subsystem controls unit 363 is coupled to a touch activity & status detection unit 367, an active noise rejection unit 368, a touch reference estimation, baselining & adaption unit 369, and clocks & timing circuitry 365. The clocks & timing circuitry 365 may receive a reference clock from the Temperature-Compensated Crystal Oscillator (TXCO), Phase-Locked Loops (PLLs) & Clock Generators 366. The TXCO, PLLs, and clock generators component 366 may communicate with other timing components of the portable device located outside of the touch signal processing architecture 300. The real-time raw touch-signal interface 361, touch activity & status detection unit 367, active noise rejection unit 368, touch reference estimation, and baselining & adaption unit 369 are also coupled to a correlated sampling unit 372. The touch reference estimation, baselining, and adaptation unit is also coupled to an analog front-end unit 370. The analog front-end unit 370 may communicate with the scanning engine 364 to receive an analog touch signal based on a user touch on the touch screen, and may convert the analog touch signal to a digital touch signal to create touch signal raw data. The analog front-end unit 370 may include row/column drivers and an analog-to-digital converter (ADC). The scanning engine 364 may also be coupled to the touch-subsystem controls 363.

The platform hardware/touchscreen subsystem layer 360 also includes battery, charging-circuit and power manager unit 374. The battery, charging-circuit and power manager unit 374 may interface with another power subsystem of the portable device located outside of the touch signal processing architecture 300. In some embodiments, the power manager unit 371 may exist separately from the battery, charging-circuit and power manager unit 374. The power manager unit 371 may be coupled to the scanning engine 364.

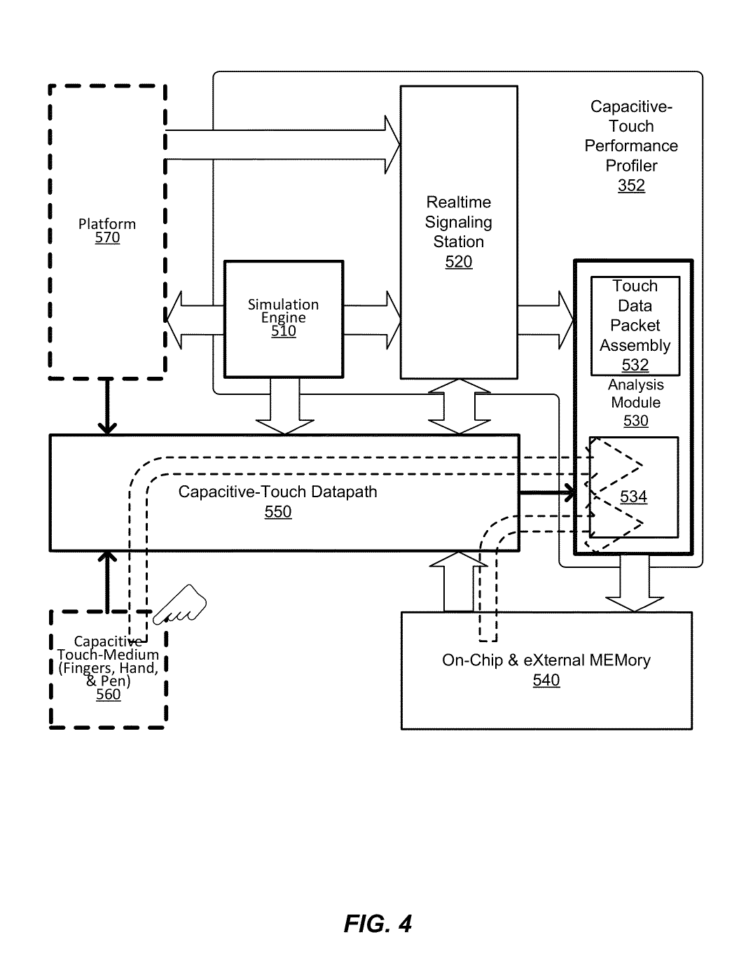

The OS kernel layer 340 includes a plurality of modules that make up a raw touch-signal processor. These modules that make up the raw touch-signal processor include a real-time raw touch-signal protocol processing module 348 communicatively coupled to the real-time raw touch-signal interface 361 of the platform hardware/touchscreen subsystem layer 360, digital filtering module 341 coupled to the real-time raw touch-signal protocol processing module 348, Gaussian Blur-Subtraction module 342 coupled to the digital filtering module 341, blob analysis module 343 coupled to the Gaussian Blur-Subtraction module 342, false-touch rejection module 344 coupled to the blob analysis module 343, final touch filtering module 345 coupled to the false-touch rejection module 344, fine-touch interpolation module 346 coupled to the final touch filtering module 345, and touch coordinate & size calculation module 347 coupled to the fine-touch interpolation module 346. The touch coordinate & size calculation module 347 is also coupled to the OS input layer 353. The real-time raw touch-signal protocol processing module 348 is also coupled to the touch interface driver 349. The OS kernel layer 340 also includes a kernel IRQ handler 351 coupled to a touch-driver IRQ handler 350. The touch-driver IRQ handler 350 is coupled to the touch interface driver 349. The touch interface driver 349 receives interrupt requests from the touch-driver IRQ handler 350 and the kernel IRQ handler 351. The touch subsystem controls 363 of the platform hardware/touchscreen subsystem layer 360 may communicate to the kernel IRQ handler 351 the presence of a user touch. The kernel IRQ handler 351 may communicate a trigger signal to the touch-driver IRQ handler 350 which may in turn communicate a trigger signal to the touch interface driver 349. The OS kernel layer 340 also includes the touch performance profiler 352 which is also coupled to the OS input layer 353 and the touch coordinate & size calculation module 347. The touch performance profiler is described in more detail with respect to FIG. 4.

The touch libraries 330 include touch library & hardware abstraction layer 333, touch service library 332, and touch manager library 331. The touch library & hardware abstraction layer 333 is communicatively coupled to the OS input layer 353 of the OS kernel layer 340.

The application framework layer 310 includes kernel input handler 321 coupled to “get event” module 320. The “get event” module 320 is coupled to the “read event” module 319. The “read event” module 319 is coupled to the input-reader thread 318. The input-reader thread 318 is coupled to the input-event queue 317. The input-event queue 317 is coupled to the input-dispatcher thread 311. The input-dispatcher thread 311 is coupled to the input publisher 312. The input publisher 312 is coupled to the touch primitive detection module 313. The touch primitive detection module 313 is coupled to the touch primitive tracking module 314. The touch primitive tracking module 314 is coupled to the symbol ID & gesture recognition module 315. The symbol ID & gesture recognition module 315 is coupled to the native input queue 316. The touch primitive detection module 313, touch primitive tracking module 314, and the symbol ID & gesture recognition module 315 make up the high-level operating system touch processing subsystem.

The application environment layer 308 includes input handler 306 which is coupled to the native input queue 316 of the application framework layer 310. The input handler 306 is coupled to an objects-in-focus module 305. The objects-in-focus module 305 is coupled to an inertia-processor 304. The inertia-processor 304 is coupled to the manipulation events module 303. The manipulation events module 303 is coupled to the manipulation events interface 302. The manipulation events interface 302 is coupled to the touch test application 301.

FIG. 4 is a diagram illustrating components of the touch performance profiler 352. As described above, the touch performance profiler 352 may measure many performance attributes of the touch signal processing architecture 300, and more specifically the raw touch-signal processor (including the real-time raw touch-signal protocol processing module 348, the digital filtering module 341, the Gaussian Blur-Subtraction module 342, the blob analysis module 343, the false-touch rejection module 344, the final touch filtering module 345, the fine-touch interpolation module 346, and the touch coordinate & size calculation module 347). The performance attributes may include, but are not limited to: scan-rate/report-rate (Hz); power (mW: active, standby/idle, and sleep); latency (msec: first-touch, touch-to-touch, and new-touch); linearity error (%); stability/jitter (%); center accuracy & border accuracy (mm/error-rate %); small touch support (mm); touch separation (mm); maximum touch tracking; low ground mass; and bending problems.

The use of the touch performance profiler 352 to measure the various performance attributes provides many benefits. The touch performance profiler 352 may be used by various internal engineering teams with varying familiarity and/or competency with regards to touch technology. The internal engineering teams may profile and analyze power and system level performance to model and improve the touch data path in touch signal processing architectures 300. Further, beyond enabling basic black-box touch performance profiling, the touch performance profiler 352 can be rigged with triggers for white-box testing. White-box testing provides a powerful tool for debugging the touch performance and engineering platform reliability of the touch signal processing architecture 300.

The touch performance profiler 352 may also be used by customers to independently tune and calibrate the touch data path in their platform to attain the required quality of service (QoS) and/or quality of experience (QoE) for their commercial devices (e.g., smartphone, tablet computer, etc.). Customers may also accurately profile power usage, resulting from the touch processor, of their devices by using the touch performance profiler 352.

The touch performance profiler 352 may also be used by developers to optimize and/or tune touch performance on their target platform for their software application. The developers may still be able to universally share meaningful performance indicators. Additionally, the touch performance profiler 352 may help customers and engineers to correlate touch performance data from many disparate developer platforms and evaluate performance of the software development kits (SDKs).

Another benefit of the touch performance profiler 352 may be that it reduces time to market by accurately profiling touch performance for performance critical applications like gaming.

Unlike graphics applications that are built with nearly a fixed-function data path with little to no adaptation, touch processing is adaptive to minimize the effect on variables affecting its performance. That is, graphics processing typically has only one path and is independent of outside influences, whereas touch processing is directly affected by other processes, e.g., moisture, brightness, heat, etc. Accordingly, optimizing based on user touch size and charge transfer characteristics, adjusting touch transducer sensitivity, scaling touch conversion, baselining touch, display de-noising, temperature compensation, waterproofing (to minimize the effect of humidity), and touch forwarding can all be adapted within the touch signal processing architecture 300. The touch performance profiler 352 may guide all such adaptations and using long-term statistical analysis of the profiling results, can learn the user's touch size and adjust the charge transfer rate, and can measure the baseline noise drift and adjust transducer sensitivity to maximize touch signal-to-noise ratio (SNR), etc. Also, using real-time signals, the touch performance profiler 352 can function as a test application by directing touch data path configuration and measuring performance in specific conditions. In some embodiments, the touch testing can be automated.

The touch performance profiler 352 includes simulation engine 510, real-time signaling station 520, and analysis module 530. The simulation engine 510 may be communicatively coupled to the touch platform 570, the real-time signaling station 520, and the capacitive-touch data path 550. The simulation engine 510 may be configured to configure the touch platform 570 and the capacitive-touch data path 550 for black-box analysis of touch performance including direct injection of simulated touch data into the capacitive-touch data path 550.

The real-time signaling station 520 may be communicatively coupled to the touch platform 570 the simulation engine 510, the capacitive-touch data path 550, and the analysis module 530. The real-time signaling station station 520 may be configured to fetch signals throughout the touch platform 570 including the capacitive-touch data path 550 to identify specific operating conditions for white-box analysis of the touch processing.

The analysis module 530 may be communicatively coupled to the real-time signaling station 520 and the on-chip and external memory 540. It can be appreciated that the on-chip and external memory 540 may be external to the touch performance profiler 352. The analysis module 530 may also include a touch data packet assembly module 532 and a real-time touch data conditioning and analysis module 534. The analysis module 530 may be configured to perform non-intrusive real-time analysis and perform real-time data packet assembly for offline analysis of the touch processing.

It can be appreciated that the touch platform 570 may include one or more elements of the touch signal processing architecture 300 described with respect to FIG. 3. It can also be appreciated that the capacitive-touch data path 550 may include one or more elements from various hardware and/or software modules described with respect to FIG. 3. For example, the capacitive-touch data path 550 may include, but is not limited to, analog front-end 370, touch reference estimation, baselining & adaptation module 369, correlated sampling module 372, real-time raw touch-signal interface 361, real-time raw touch-signal protocol processing module 348, digital filtering module 341, Gaussian Blur-Subtraction module 342, blob analysis module 343, false-touch rejection module 344, final touch filtering module 345, false-touch interpolation module 346, and the touch coordinate & size calculation module 347. The capacitive-touch data path 550 may receive a touch input from a capacitive touch-medium 560 (e.g., user's finger, user's hand, pen, stylus, etc.).

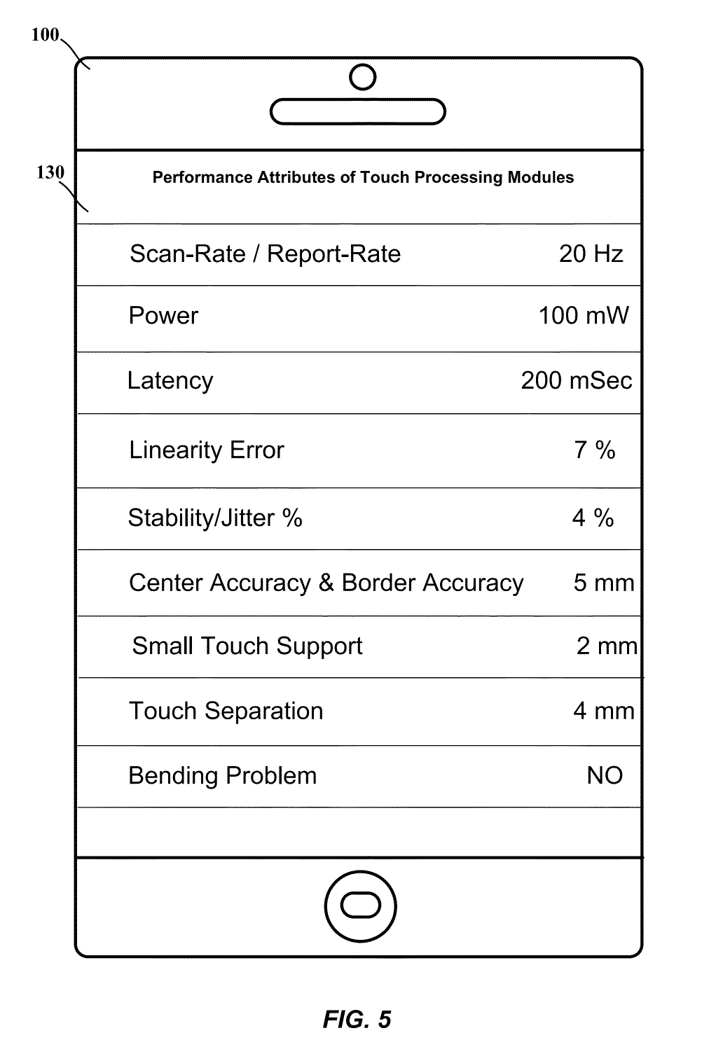

It can be appreciated that the touch performance profiler 352 may monitor one or more the hardware and/or software modules described above in real-time. That is, upon receiving a touch input via the capacitive touch-medium 560, the capacitive touch performance profiler 352 may monitor modules in the capacitive-touch data path 550 in real-time. The simulation engine 510 may simulate one or more real-world variables that may affect the performance attributes of the modules. For example, the simulation engine 510 may simulate heat, noise, moisture, or any other real-world variable that would affect touch performance. As described above, in some embodiments, the simulation engine 510 may also simulate touch data to the various modules in the capacitive-touch data path 550. The real-time signaling station 520 may fetch the signals from the capacitive-touch data path 550 used by the analysis module 530 for the determining and analyzing the performance attributes of the touch data path. The performance attributes may include, but is not limited to, data indicative of scan-rate of the touchscreen, power consumption of the touchscreen system, latency of the touchscreen system, linearity error, stability, or accuracy of the touchscreen. In some embodiments, the performance attributes may be presented to an end-user via a display device that is communicatively coupled to the touchscreen system. Examples of the output performance attributes are described with respect to FIG. 5.

Prior to outputting the performance attributes, the analysis module 530 may analyze the obtained data, either in real-time or offline. The real-time analysis may be performed by the real-time touch data conditioning & analysis module 534. The offline analysis may be performed via the touch data packet assembly 532, by performing real-time data packet assembly for offline analysis by the analysis module 530. The offline analysis may provide multiple samples and statistics for the various modules within the capacitive-touch data path 550.

It can be appreciated that as a result of the touch performance profiler 352 existing with the OS kernel layer 340 and having taps on each line within the capacitive-touch data path 550, a greater amount of transparency for testing is realized. Typical touch performance evaluating systems and methods that exist in the application framework layer 310 or application environment layer 308 provide only limited testing visibility into the various hardware and/or software modules within the capacitive-touch data path 550. Using the “white-box” testing approach as disclosed herein, it would be readily apparent to the end-user if one or more hardware and/or software modules within the capacitive-touch data path 550 are in a failing state.

In some embodiments, the use of touch stencils may be employed for profiling touch performance. Stencil cutouts may be placed over the touchscreen sensor to restrict finger motion over the touchscreen. Different cutouts may guide swipes across specific locations of the touchscreen and evaluate other touch gestures and nodes. By fitting a known polynomial to the cutout stencil, ground truth points may be readily identified. Depending on the line curvature, the order of the polynomial may vary. However, 2^{nd}-order binomials may be sufficient for testing linearity, accuracy, and jitter. Stencil guided touch provides many benefits such as being fluster, easier, and avoiding the need for expensive robotic techniques. Further, stencil guided touch alleviates the need for error prone synchronization between a robot readout and touch samples. The proposed method may be automatically synchronized to the touch data. Accordingly, the absolute ground-truth is available.

### Exemplary Touch Performance Profiling Results

FIG. 5 illustrates a number of performance attributes displayed to a user via a display 130 on a portable device 100. As illustrated in FIG. 1, the portable device 100 may include the touch performance profiler 352. The performance attributes illustrated on the display 130 include: scan-rate/report-rate, power, latency, linearity error, stability/jitter %, center accuracy & border accuracy, small touch support, touch separation, and bending problem. It can be appreciated that the performance attributes depicted are merely examples and the display 130 may show more, less, or other performance attributes. In some embodiments, the performance attributes may be highlighted or presented with different colors of text to provide further information about the performance attributes. For example, a performance attribute presented in red text could indicate that the measured value is outside of the normal range and that a problem exists. On the other hand, a performance attribute presented in green text could indicate that the measured value is within the normal range and that no problem exists.

In this particular example, the performance attributes indicate that the evaluation of the touch processing system yielded the following results: scan-rate/report-rate—20 Hz; power—100 mW; latency—200 msec; linearity error—7%; stability/jitter %—4%; center accuracy & border accuracy—5 mm; small touch support—2 mm; touch separation—4 mm; bending problem—NO. In some embodiments, the display 130 may present a list of the various hardware/software modules within the capacitive-touch data path 550 and indicate whether these modules are in a pass or fail state.

### Exemplary Methods

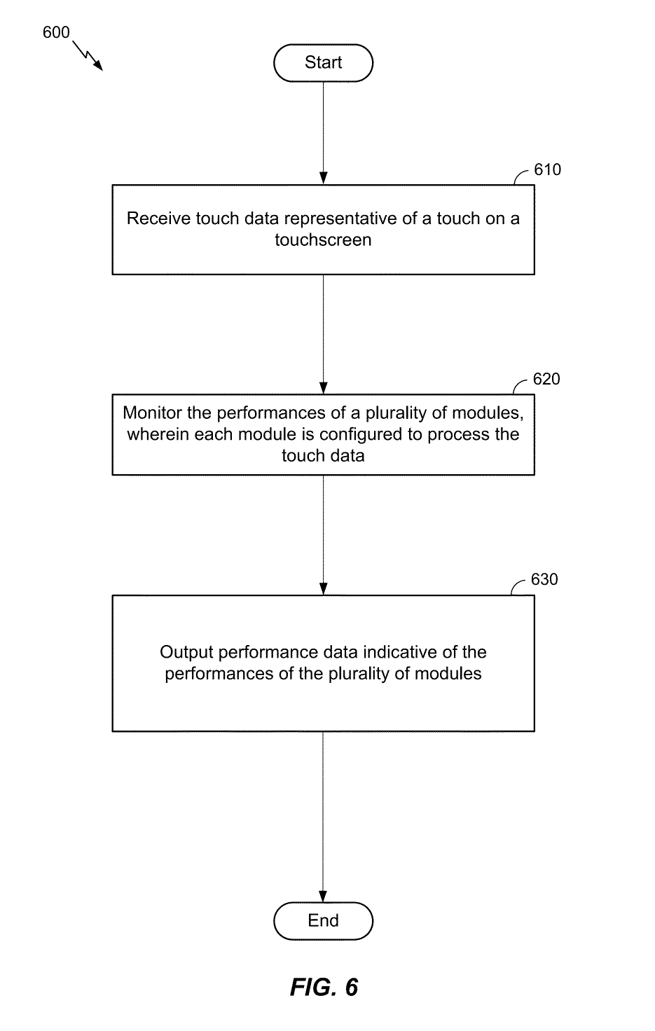

FIG. 6 is a flowchart of an exemplary method of evaluating touch processing on a touchscreen system. In block 610, touch data is received representative of a touch on a touchscreen. The touch data may be received via a capacitive touch-medium, e.g., a user's fingers, a user's hands, a stylus device, etc. For example, in FIG. 4, the touch data is received via the capacitive touch-medium.

In block 620, the performance of a plurality of modules in monitored. Each module is configured to process the touch data. The plurality of modules may be hardware and/or software modules within a capacitive-touch data path. The plurality of modules may be configured to perform different aspects of touch processing on the received touch data. For example, in FIG. 3, a plurality of modules are described within the touch data path. The capacitive-touch data path may be communicatively coupled to a touch performance profiler. For example, in FTC. 4, the capacitive-touch data path is coupled to the capacitive-touch performance profiler. The touch performance profiler may monitor the plurality of modules in real-time. The touch performance profiler may reside within a kernel layer of an operating system and may be configured to analyze the performance data of the plurality of modules based on monitoring of the modules. The analysis may be performed in real-time or offline. In some embodiments, the touch performance profiler may simulate one or more real-world variables that affect the performance data of at least one of the modules, prior to performing the analysis. These real-world variables may include, but is not limited to, heat, noise, moisture, or brightness.

In block 630, performance data is outputted. The performance data is indicative of the performances of the plurality of modules. The output performance data may include data indicative of scan-rate of the touchscreen, power consumption of the touchscreen system, latency of the touchscreen system, linearity error, stability, or accuracy of the touchscreen. The performance data may be displayed to an end-user via a display device. For example, in FIG. 5, the outputted performance data is presented to an end-user via a display of the portable device. The outputted performance data may also include, based on the analysis, results indicative of the performance of the touchscreen system. The performance data could also include a pass or fail result or at least one of the plurality of modules.

### Exemplary Computing System

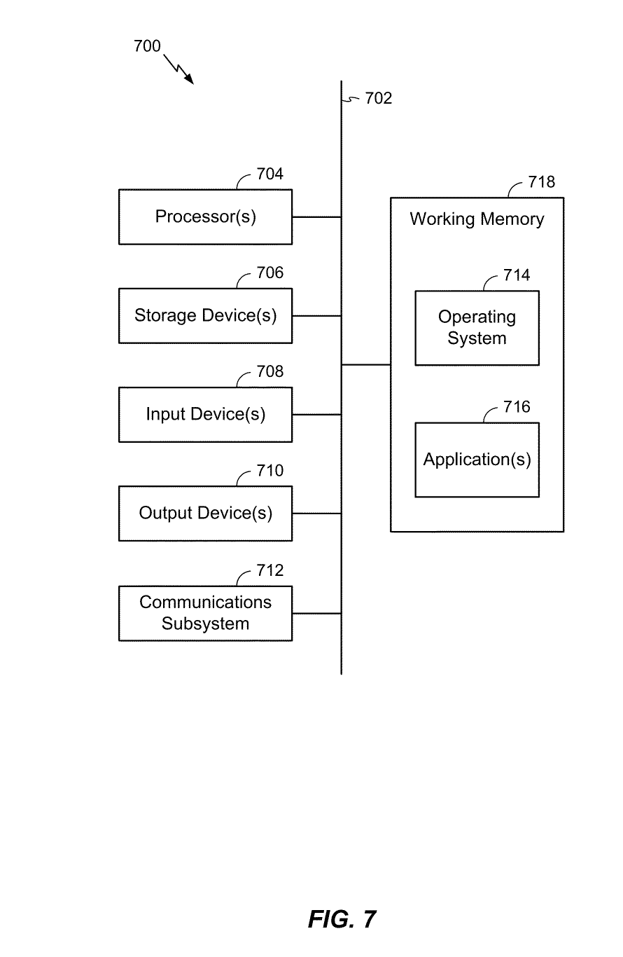

Having described multiple aspects of improving assistance data parameters in floor plan maps for indoor positioning, an example of a computing system in which various aspects of the disclosure may be implemented will now be described with respect to FIG. 7. According to one or more aspects, a computer system as illustrated in FIG. 7 may be incorporated as part of a computing device, which may implement, perform, and/or execute any and/or all of the features, methods, and/or method steps described herein. For example, computer system 700 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. In some embodiments, the computer system 700 is configured to implement any of the methods described above. FIG. 7 provides a schematic illustration of one embodiment of a computer system 700 that can perform the methods provided by various other embodiments, as described herein, and/or can function as the host computer system, a remote kiosk/terminal, a point-of-sale device, a mobile device, a set-top box, and/or a computer system. FIG. 7 is meant only to provide a generalized illustration of various components, any and/or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, wireless receivers, wireless sensors, a mouse, a keyboard and/or the like; and one or more output devices 720, which can include without limitation a display unit, a printer and/or the like. In some embodiments, the one or more processors 710 may be configured to perform a subset or all of the functions described above with respect to FIG. 1. The processor 710 may comprise a general processor and/or and application processor, for example. In some embodiments, the processor is integrated into an element that processes visual tracking device inputs and wireless sensor inputs.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 730, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above, in some embodiments, communications subsystem 730 may interface with transceiver(s) 750 configured to transmit and receive signals from access points or mobile devices. Some embodiments may include a separate receiver or receivers, and a separate transmitter or transmitters.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 7, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

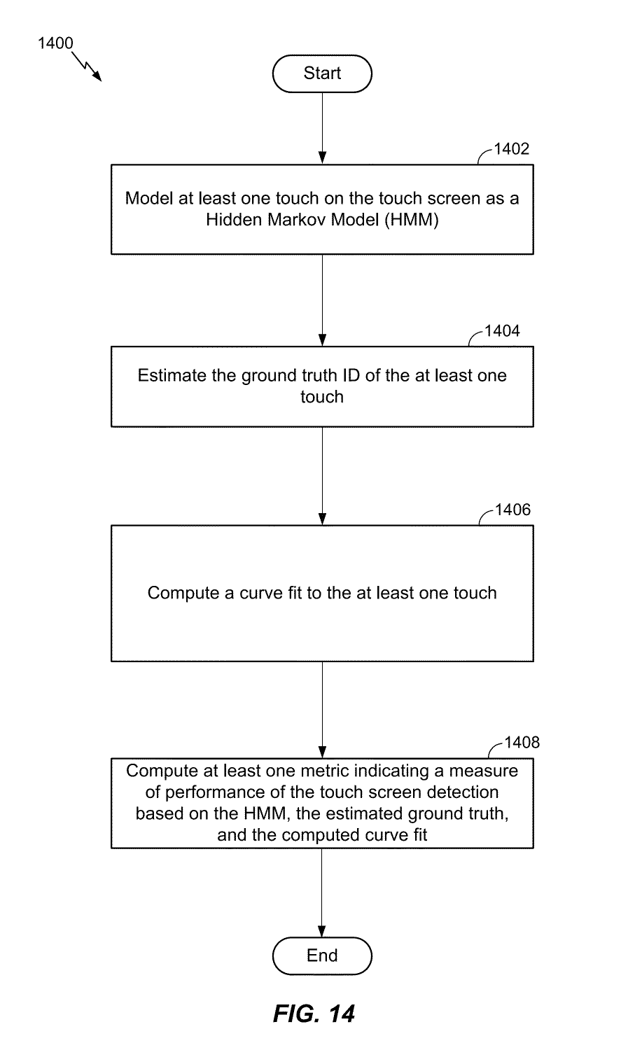

Some embodiments may employ a computer system (such as the computer system 700) to perform methods in accordance with the disclosure. For example, some or of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein, for example methods described with respect to FIGS. 6 and 14.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710. Memory 735 may contain at least one database according to any of the databases and methods described herein. Memory 735 may thus store any of the values discussed in any of the present disclosures, including FIGS. 1, 2, 3, 4, 5, 6, 7, 8, 9, 10, 11, 12A-12B 13A-13D, 14 and related descriptions.

The methods described in FIGS. 6 and 14 may be implemented by various blocks in FIG. 7. For example, processor 710 may be configured to perform any of the functions of blocks in flowchart 600 or 1400. Storage device 725 may be configured to store an intermediate result, such as a globally unique attribute or locally unique attribute discussed within any of blocks mentioned herein. Storage device 725 may also contain a database consistent with any of the present disclosures. The memory 735 may similarly be configured to record signals, representation of signals, or database values necessary to perform any of the functions described in any of the blocks mentioned herein. Results that may need to be stored in a temporary or volatile memory, such as RAM, may also be included in memory 735, and may include any intermediate result similar to what may be stored in storage device 725. Input device 715 may be configured to receive wireless signals from satellites and/or base stations according to the present disclosures described herein. Output device 720 may be configured to display images, print text, transmit signals and/or output other data according to any of the present disclosures.

### Additional Embodiments

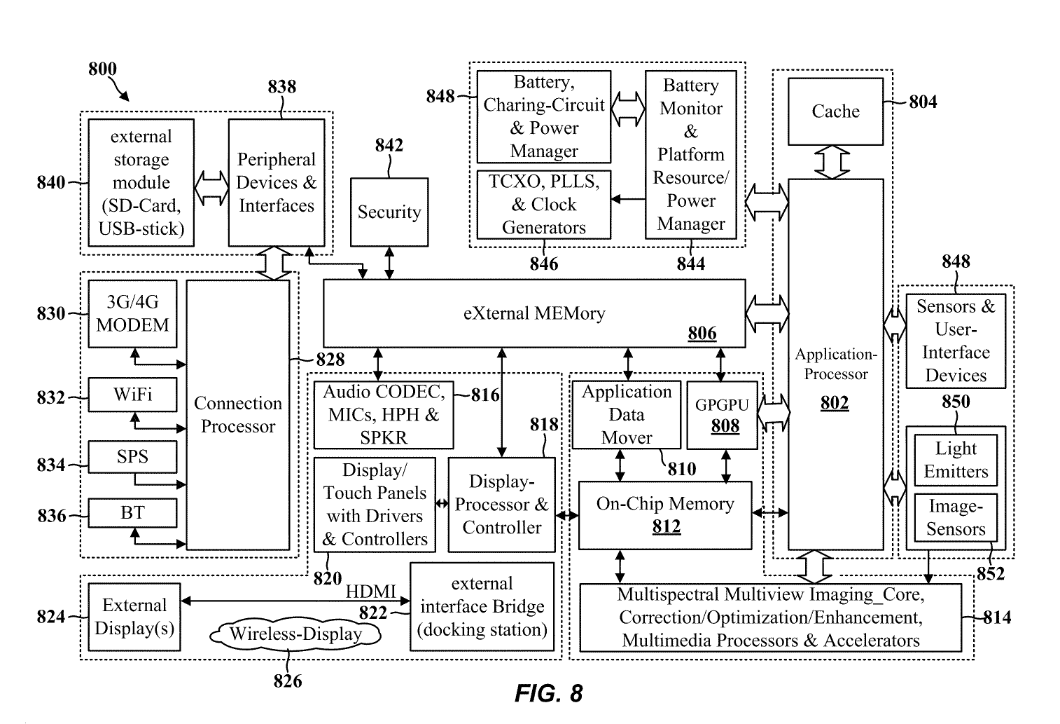

FIG. 8 is a diagram illustrating an example of mobile device architecture 800 with a touch screen display and an external display device according to some embodiments. In this example, the mobile device architecture 800 includes an application processor 802, a cache 804, an external memory 806, a general-purpose graphics processing unit (GPGPU) 808, an application data mover 810, an on-chip memory 812 that is coupled to the application data mover 810 and the GPGPU 808, and a multispectral multiview imaging core, correction/optimization/enhancement, multimedia processors and accelerators component 814 that is coupled to the on-chip memory 812. The application processor 802 communicates with the cache 804, the external memory 806, the GPGPU 808, the on-chip memory 812, and the multispectral multiview imaging core, correction/optimization/enhancement multimedia processors and accelerators component 814. The mobile device architecture 800 further includes an audio codec, microphones, headphone/earphone, and speaker component 816, a display processor and controller component 818, and a display/touch panels with drivers and controllers component 820 coupled to the display processor and controller component 818. The mobile device architecture 800 may optionally include an external interface bridge (e.g., a docking station) 822 coupled to the display processor and controller component 818, and an external display 824 coupled to the external interface bridge 822. The external display 824 may be coupled to the external interface bridge 822 via a wireless-display connection 826 or a wired connection, such as a high-definition multimedia interface (HDMI) connection. The mobile device architecture 800 further includes a connection processor 828 coupled to a 3G/4G modem 830, a Wi-Fi modem 832, a Satellite Positioning System (SPS) sensor 834, and a Bluetooth module 836. The mobile device architecture 800 also includes peripheral devices and interfaces 838 that communicate with an external storage module 840, the connection processor 828, and the external memory 806. The mobile device architecture also includes a security component 842. The external memory 806 is coupled to the GPGPU 808, the application data mover 810, the display processor and controller component 818, the audio codec, microphones, headphone/earphone and speaker component 816, the connection processor 828, the peripheral devices and interfaces 838, and the security component 842.

In some embodiments, the mobile device architecture 800 further includes a battery monitor and platform resource/power manager component 844 that is coupled to a battery charging circuit and power manager component 848 and to temperature compensated crystal oscillators (TCXOs), phase-lock loops (PLLs), and clock generators component 846. The battery monitor and platform resource/power manager component 844 is also coupled to the application processor 802. The mobile device architecture 800 further includes sensors and user-interface devices component 848 coupled to the application processor 802, and includes light emitters 850 and image sensors 852 coupled to the application processor 802. The image sensors 852 are also coupled to the multispectral multiview imaging core, correction/optimization/enhancement, multimedia processors and ace orators component 814.

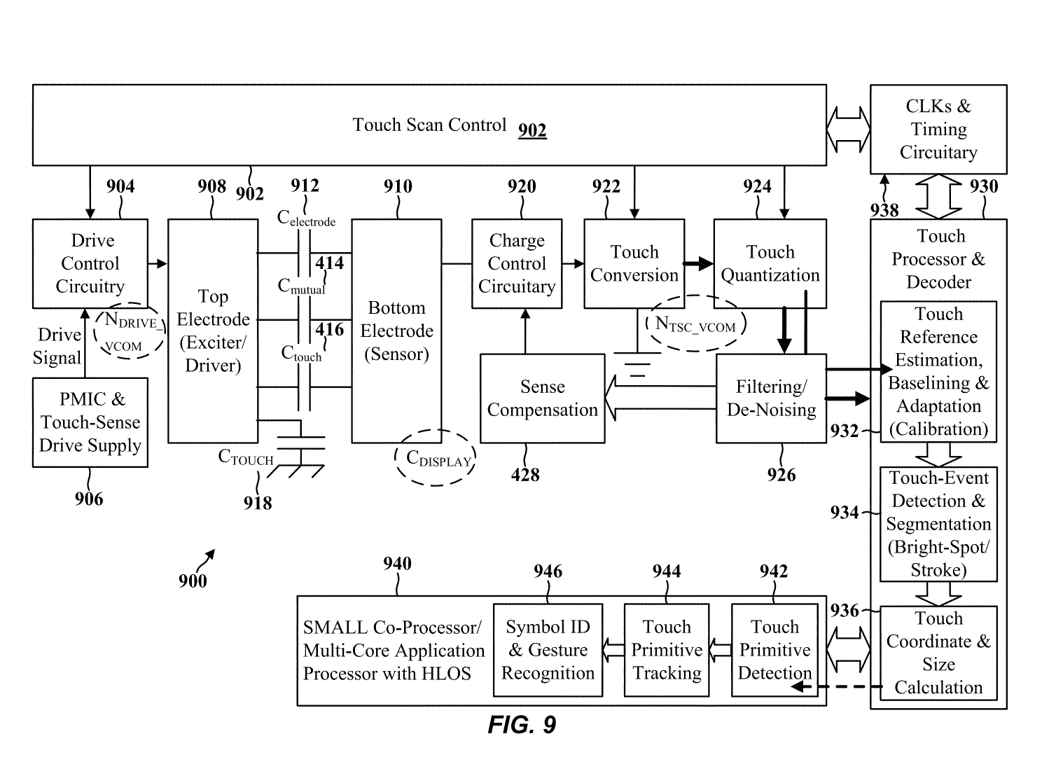

FIG. 9 illustrates an example of a capacitive touch processing data path in a touch screen device 900 according to some embodiments. The touch screen device 900 has a touch scan control unit 902 that is coupled to drive control circuitry 904, which receives a drive signal from a power management integrated circuit (PMIC) and touch-sense drive supply unit 906. The drive control circuitry 904 is coupled to a top electrode 908. The capacitive touch screen includes two sets of electrodes, where the first set includes the top electrode 908 (or an exciter/driver electrode) and the second set includes a bottom electrode 910 (or a sensor electrode). The top electrode 908 is coupled to the bottom electrode 910 with capacitance between the top electrode 908 and the bottom electrode 910. The capacitance between the top electrode 908 and the bottom electrode 910 includes an electrode capacitance (celectrode) 912, a mutual capacitance (cmutual) 914, and a touch capacitance (ctouch) 916. A user touch capacitance (CTOUCH) 918 may form when there is a user touch on the top electrode 908 of the touch screen. With the user touch on the top electrode 908, the user touch capacitance 918 induces capacitance on the top electrode 908, thus creating a new discharge path for the top electrode 908 through the user touch. For example, before a user's finger touches the top electrode 908, the electrical charge available on the top electrode 908 is routed to the bottom electrode 910. A user touch on a touch screen creates a discharge path through the user touch, thus changing a discharge rate of the charge at the touch screen by introducing the user touch capacitance 918. The user touch capacitance 918 created by a user touch may be far greater than capacitances between the top electrode 908 and the bottom electrode 910 (e.g., the electrode capacitance 912, the mutual capacitance 914, and the touch capacitance 916), and thus may preempt the other capacitances (e.g., celectrode 912, cmutual 914, and ctouch 916) between the top electrode 908 and the bottom electrode 910.

The bottom electrode 910 is coupled to charge control circuitry 920. The charge control circuitry 920 controls a touch signal received from the top and bottom electrodes 908 and 910, and sends the controlled signal to a touch conversion unit 922, which converts the controlled signal to a proper signal for quantization. The touch conversion unit 922 sends the converted signal to the touch quantization unit 924 for quantization of the converted signal. The touch conversion unit 922 and the touch quantization unit 924 are also coupled to the touch scan control unit 902. The touch quantization unit 924 sends the quantized signal to a filtering/de-noising unit 926. After filtering/de-noising of the quantized signal at the filtering/de-noising unit 926, the filtering/de-noising unit 926 sends the resulting signal to a sense compensation unit 928 and a touch processor and decoder unit 930. The sense compensation unit 928 uses the signal from the filtering/de-noising unit 926 to perform sense compensation and provide a sense compensation signal to the charge control circuitry 920. In other words, the sense compensation unit 928 is used to adjust the sensitivity of the touch sensing at the top and bottom electrodes 908 and 910 via the charge control circuitry 920.

In some embodiments, the touch processor and decoder unit 930 communicates with clocks and timing circuitry 938, which communicates with the touch scan control unit 902. The touch processor and decoder unit 930 includes a touch reference estimation, a baselining, and adaptation unit 932 that receives the resulting signal from the filtering/de-noising unit 926, a touch-event detection and segmentation unit 934, and a touch coordinate and size calculation unit 936. The touch reference estimation, baselining, and adaptation unit 932 is coupled to the touch-event detection and segmentation unit 934, which is coupled to the touch coordinate and size calculation unit 936. The touch processor and decoder unit 930 also communicates with a small co-processor/multi-core application processor 940 with HLOS, which includes a touch primitive detection unit 942, a touch primitive tracking unit 944, and a symbol ID and gesture recognition unit 946. The touch primitive detection unit 942 receives a signal from the touch coordinate and size calculation unit 936 to perform touch primitive detection, and then the touch primitive tracking unit 944 coupled to the touch primitive detection unit 942 performs the touch primitive tracking. The symbol ID and gesture recognition unit 946 coupled to the touch primitive tracking unit 944 performs recognition of a symbol ID and/or gesture.

Various touch sensing techniques are used in the touch screen technology. Touch capacitance sensing techniques may include e-field sensing, charge transfer, force-sensing resistor, relaxation oscillator, capacitance-to-digital conversion (CDC), a dual ramp, sigma-delta modulation, and successive approximation with single-slope ADC. The touch capacitance sensing techniques used in today's projected-capacitance (P-CAP) touch screen controller may include a frequency-based touch-capacitance measurement, a time-based touch-capacitance measurement, and/or a voltage-based touch-capacitance measurement.

In the frequency-based measurement, a touch capacitor is used to create an RC oscillator, and then a time constant, a frequency, and/or a period are measured according to some embodiments. The frequency-based measurement includes a first method using a relaxation oscillator, a second method using frequency modulation and a third method a synchronous demodulator. The first method using the relaxation oscillator uses a sensor capacitor as a timing element in an oscillator. In the second method using the frequency modulation, a capacitive sensing module uses a constant current source/sink to control an oscillator frequency. The third method using the synchronous demodulator measures a capacitor's AC impedance by exciting the capacitance with a sine-wave source and measuring a capacitor's current and voltage with a synchronous demodulator four-wire ratiometric coupled to the capacitor.

The time-based measurement measures charge/discharge time dependent on touch capacitance. The time-based measurement includes methods using resistor capacitor charge timing, charge transfer, and capacitor charge timing using a successive approximation register (SAR). The method using resistor capacitor charge timing measures sensor capacitor charge/discharge time for with a constant voltage. In the method using charge transfer, charging the sensor capacitor and integrating the charge over several cycles, ADC or comparison to a reference voltage, determines charge time. Many charge transfer techniques resemble sigma-delta ADC. In the method using capacitor charge timing using the SAR, varying the current through the sensor capacitor, matches a reference ramp.

The voltage-based measurement monitors a magnitude of a voltage to sense user touch. The voltage-based measurement includes methods using a charge time measuring unit, a charge voltage measuring unit, and a capacitance voltage divide. The method using the charge time measuring unit charges a touch capacitor with a constant current source, and measures the time to reach a voltage threshold. The method using the charge voltage measuring unit charges the capacitor from a constant current source for a known time and measures the voltage across the capacitor. The method using the charge voltage measuring unit requires a very low current, high-precision current source, and high-impedance input to measure the voltage. The method using the capacitance voltage divide uses a charge amplifier that converts the ratio of the sensor capacitor to a reference capacitor into a voltage (Capacitive-Voltage-Divide). The method using the capacitance voltage divide is the most common method for interfacing to precision low-capacitance sensors.

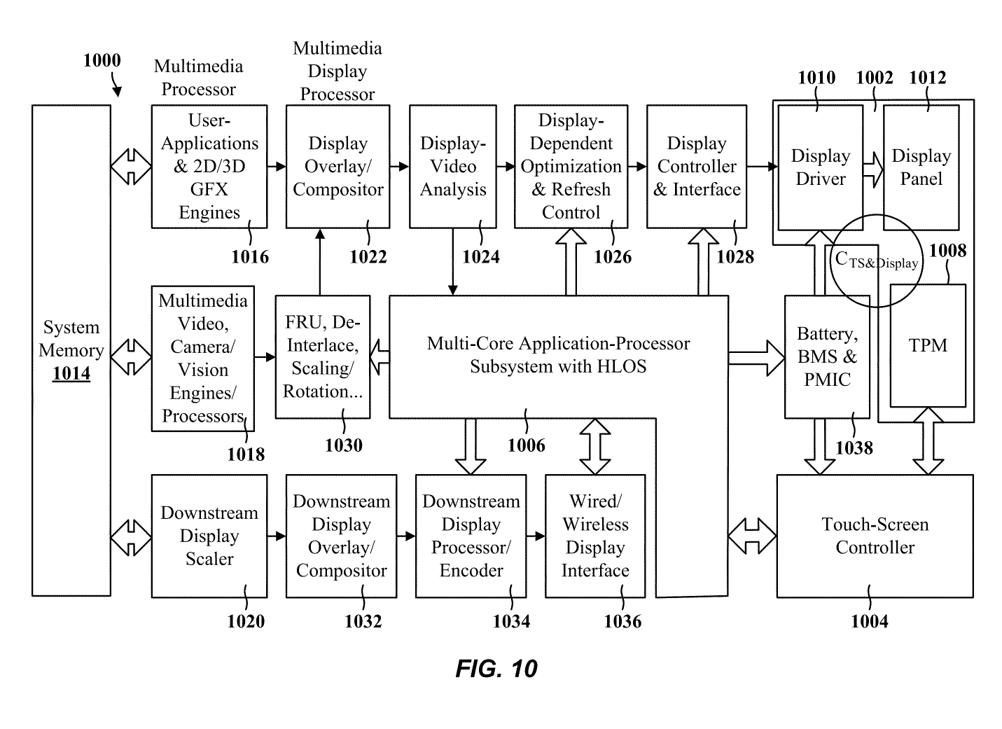

FIG. 10 illustrates a closer look at display and touch subsystems in mobile-handset architecture according to some embodiments. The mobile handset 1000 includes a touch screen display unit 1002, a touch screen controller 1004, and a multi-core application processor subsystem with HLOS 1006. The touch screen display unit 1002 includes a touch panel module (TPM) unit 1008 coupled to the touch screen controller 1004, a display driver 1010, and a display panel 1012 that is coupled to the display driver 1010. The mobile handset 1000 also includes a system memory 1014, and further includes a user-applications and 2D/3D graphics/graphical effects (GFX) engines unit 1016, a multimedia video, camera/vision engines/processor unit 1018, and a downstream display scaler 1020 that are coupled to the system memory 1014. The user-applications and 2D/3D GFX engines unit 1016 communicates with a display overlay/compositor 1022, which communicates with a display-video analysis unit 1024. The display-video analysis unit 1024 communicates with a display-dependent optimization and refresh control unit 1026, which communicates with a display controller and interface unit 1028. The display controller and interface unit 1028 communicates with the display driver 1010. The multimedia video, camera/vision engines/processor unit 1018 communicates with a frame-rate-upconverter (FRU), de-interlace, scaling/rotation component 1030, which communicates with the display overlay/compositor 1022. The downstream display scaler 1020 communicates with a downstream display overlay/compositor 1032, which communicates with a downstream display processor/encoder unit 1034. The downstream display processor/encoder unit 1034 communicates with a wired/wireless display interface 1036. The multi-core application processor subsystem with HLOS 1006 communicates with the display-video analysis unit 1024, the display-dependent optimization and refresh control unit 1026, the display controller and interface unit 1028, the FRU, de-interlace, scaling/rotation component 1030, the downstream display overlay/compositor 1032, the downstream display processor/encoder unit 1034, and the wired/wireless display interface 1036. The mobile handset 1000 also includes a battery management system (BMS) and PMIC unit 1038 coupled to the display driver 1010, the touch-screen controller 1004, and the multi-core application processor subsystem with HLOS 1006.

In some embodiments, processing of the touch signal raw data can be processed by the multi-core application processor subsystem with HLOS 1006 instead of in the touch screen controller 1004. In some such embodiments, the touch screen controller 1004 or one or more components thereof may be omitted. In other such embodiments, the touch screen controller 1004 and/or all components thereof are included, but touch signal raw data is passed through to the multi-core application processor subsystem with HLOS 1006 without or with reduced processing.

Evaluating the performance of a touch processing algorithm, or a particular implementation of a touch processing algorithm, is difficult. Standard methods may involve the use of robot arm to generate an accuracy map, as well using a robot arm to draw many lines and curves. With ground truth data generated by a robot arm, one can measure linearity, jitter, accuracy, latency, and ID tracking accuracy. However, robotic arms are very expensive, and to generate the data to evaluate a touch controller algorithm typically takes an entire day of robot use. This is detrimental to algorithm development efforts for touch screen processing where many algorithms must be systematically and accurately evaluated every day and quicker than one a day.

However, the disclosures herein present methods and apparatuses for quickly generating accurate evaluation of touch processing algorithms or touch processing implementations.

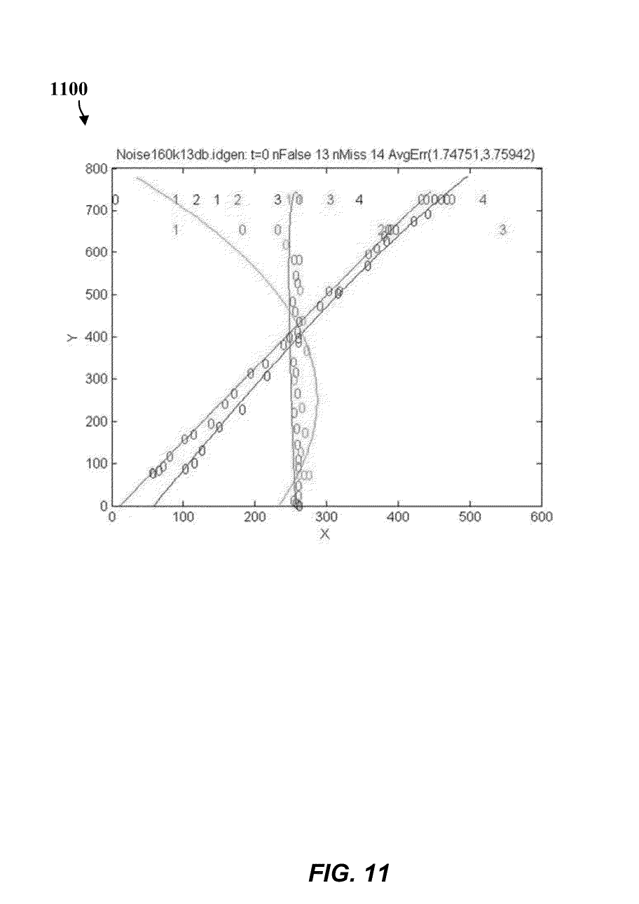

Referring to FIG. 11, example touch screen calibration plot 1100 shows four strokes detected by the touch screen, each in different colors. According to some embodiments, methods for evaluating the touch processing of these strokes may incorporate a three step calibration process including a curve-fitting estimation. In some embodiments, the evaluation (or calibration) methods may help quantify several different metrics as expressions of performance of the touch screens, including: linearity, dynamic jitter, P(missed touch), P(extra, spurious touches), accuracy, and ID tracking error (e.g. whether the same finger is being tracked across each touch input). Any or all of these metrics may be evaluated according to different embodiments, and other metrics may be measured similarly, that are apparent to those with skill in the art. By way of example, the numbers, e.g. “0,” “1,” “2,” etc., on the touchscreen 500 indicate where touches were detected. In this case, any numbers above 0 are actually spurious detections. Moreover, one can see how the “0” points somewhat form lines or curves along the touch screen, but they are not completely straight. Assuming the user made smooth swipes along the touch screen, the “0” points show that the touch screen may lack some linearity when detecting swipes in diagonal or vertical motions. These metrics may also be specific to particular regions of the touch screen. For example, the linearity in the top right corner of the touch screen may be evaluated to be quite accurate, while the linearity in the top left corner of the touch screen may be evaluated to be inaccurate. In general, the methods presented may allow for one or more swipes across the touch screen in order to test the touch screen's performance. Example processes for utilizing these swipes are described more below.

In some embodiments, the evaluation or calibration methods presented may allow for any and all kinds of swipes, for example, vertical, horizontal, diagonal swipes, second-order curves (e.g. U shapes, parabolas, etc.), zig-zags, and multiple swipes at once. In other embodiments, evaluation or calibration methods may be limited to swipes no more complex than second-order curves. In some embodiments, the tester may need to specify what kind of swipe (or how many) was made on the touch screen, in order for the methods to properly align with the data presented.

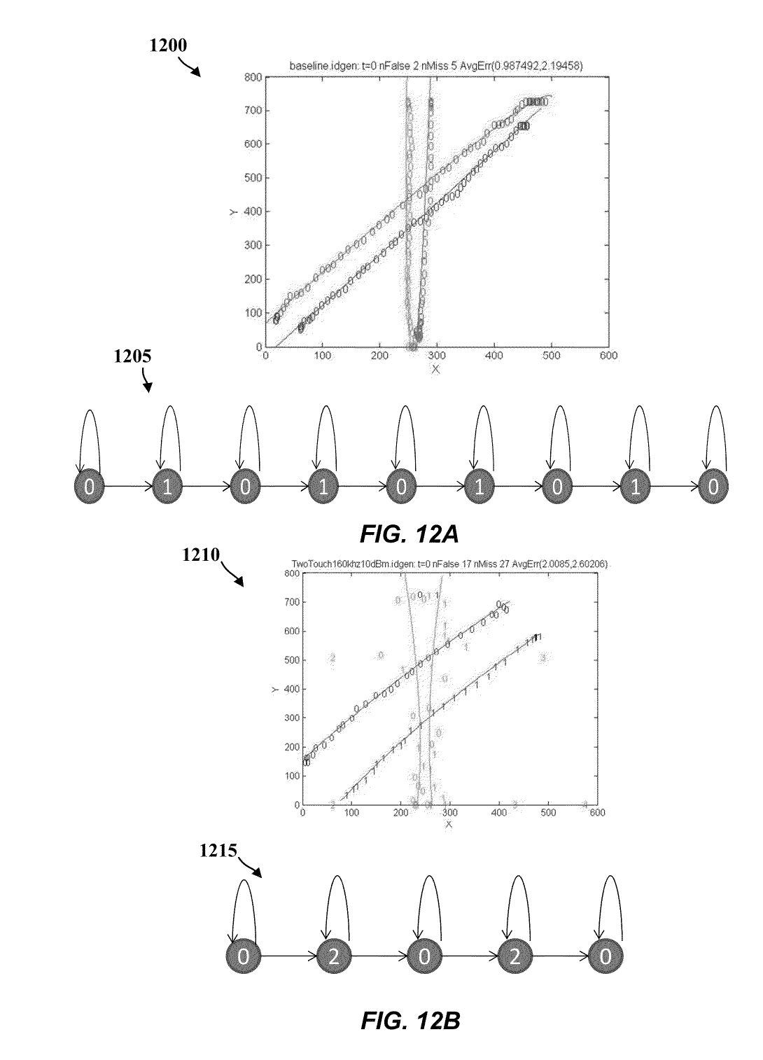

Referring to FIGS. 12A and 12B, in some embodiments, a first step in the evaluation process may involve modeling the type, number, and sequence of swipes in a hidden Markov model (“HMM technique”). The HMM technique may be used to summarize the type of swipes made, for easier evaluation, as well as determine when the testing starts and stops. In FIG. 12A, for example, the four touch swipes shown in touch screen plot 1200 may be modeled according to the HMM chain 1205. Here, four swipes of single strokes were made in succession, where each are indicated as the circles with a “1” inside them. Each circle of HMM chain 1205 represents a different state, and the arrows indicate the available paths the state can transition to at any discrete time interval. Thus, the HMM chain starts on the left, where no input is detected, hence a “0” input. Then, a first touch is detected, as indicated by the “1” transitioned to, and remains in that state until the first swipe is finished. A break in touch detection occurs, as indicated by the second “0” input. Then, a second single touch is detected, as indicated by the second “1,” and so on.

As another example, in FIG. 12B, two two-stroke touches are modeled by HMM chain 1215, consistent with touch screen plot 1210. In this case, the first input detected is two touches occurring simultaneously, and continues until both touches release from the touch screen. This is indicated by the first “2” input in HMM chain 1215. A break occurs, and then a second two-stroke touch occurs, as indicated by the second “2” input.

Having generated an accurate HMM model to represent the type of touches made in the calibration test, a second step according to some embodiments is to estimate the ground truth ID of the actual touches. This step attempts to determine what are the actual touches made, in spite the empirical data showing potentially spurious touches, missing touches, inaccurate detections, and so forth. In some embodiments, the ground truth ID estimations incorporate prior frames, e.g. the two previous frames, into determining the ground truth of the present frame. In some embodiments, the ground truth may be considered to be a function of a curve fit of the empirical data, but subject to a rotation and/or a translation. In some embodiments, the ground truth is estimated without a curve fit, hut rather incorporates simply the empirical data subject to a rotation and/or a translation.

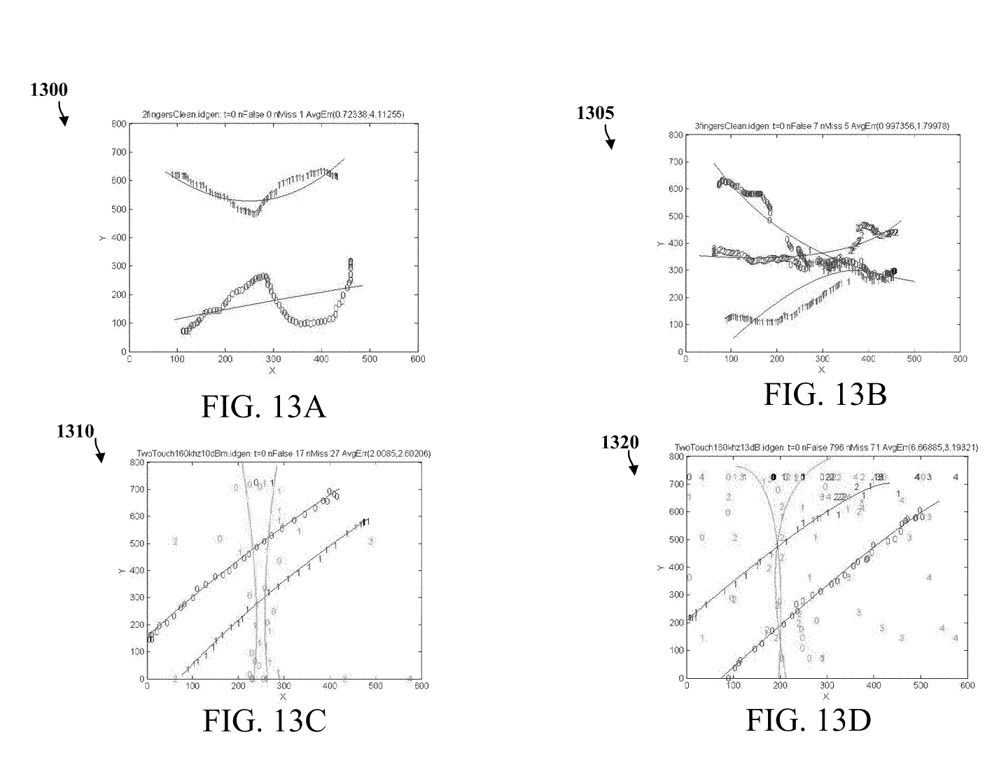

Referring to FIGS. 13A, 13B, 13C, and 13D, a third step in the evaluation method may include generating a curve fit to the modeled data. In some embodiments, a binomial curve tit is used. In some embodiments, up to a second order binomial curve fit is used. In some embodiments, higher order curve fits may be specified.

For example, in plot 1300, a two stroke plot of two fingers trying to be squeezed together is recorded. A binomial curve fit may have been implemented for each of the strokes, but as shown, it may have been preferred that a higher order curve fit should have been implemented to better evaluate the touch screen, as the movements of the fingers do not follow a simple low-order binomial curve.

As another example, in plot 1305, three strokes are recorded, with their corresponding curve fits shown as parabolic lines. Other examples, including plots 1310 and 1320, each showing two instances of two-stroke touches, are shown. Assuming the user made smooth strokes along the touch screen, the curve fits may then provide data expressing how far off (or how accurate) the touch screen detections are. Statistical methods, such as computing standard deviation, standard error, means squared error, R squared, and so forth, may be just some of the many measurements that can be used to evaluate the accuracy of the touch screen detections. In plot 1320, for example, curve fits are estimated for the data, but there is a large amount of noise or spurious data on the touch screen, as indicated by the many random and sporadic touch detections shown all over the touch screen. Thus, the plot in 1320 may not generate a very accurate curve fit, and the statistical measurements evaluating the curve fits may reflect this.

In some embodiments, testing suites or control templates may be used to further aide evaluation of the touch detection algorithms or apparatuses. For example, physical cut-out templates that are placed over the touch screen device may contain slots or holes that a user can use to follow along when making swipes or other gestures. In this way, the locations of the swipes or strokes may be more uniform, allowing comparison to other touch detection algorithms or apparatuses easier. Multiple cut-out templates may be used, with each template having a different one or more slots or holes, so as to allow for different swipes or gestures to be tested. Similarly, a testing suite may be including in some embodiments, that either incorporate these templates or other types of testing aides.

Using all three steps as described allows testers to objectively measure and comparatively measure the accuracy and performance of various touch screen algorithms and apparatuses. For example, a difference from the HMM estimated touch start/stop times may provide a measurement for P(missed touch) and P(extra, or spurious touch). As another example, a difference from estimating the ground truth in step 2, may provide a measurement for P(ID tracking error). As another example, the mean squared error from the curve fitting in step 3 may provide a measurement of jitter and linearity.

Referring to FIG. 14, an example flowchart 1400 illustrates a series of method steps according to some embodiments. At step 1402, a first step may include modeling at least one touch on the touch screen as a Hidden Markov Model (HMM). This step may be consistent with what is described in examples FIGS. 14A and 14B. In some embodiments, multiple touches may be included in the testing data, and embodiments are not so limited.

At step 1404, a second step may include estimating the ground truth ID of the at least one touch. The ground truth ID may link together which touch detections correspond to what finger or other instrument used by the tester when making the strokes on the touch screen. Step 1404 may be consistent with what is described in the second step, above.

At step 1406, a third step may include computing a curve fit to the at least one touch. In some embodiments, the curve fit may be at most a second-order curve. In other embodiments, higher order curve fits may be used. In other embodiments, other types of functions besides binomial curves may be used. In some embodiments, the tester may specify what types of strokes were made, and an appropriate curve may be generated to best model the type of stroke. Step 1406 may be consistent with what is describe in FIGS. 7A, 7B, 7C, and 7D, for example.

At step 1408, at least one metric indicating a measure of performance of the touch screen detection algorithm or apparatus may be computed, based on the HMM, the estimated ground truth, and the computed curve fit, generated in steps 1402, 1404, and 1406, respectively.

In some embodiments, a test suite may be implemented to provide a more common baseline that may more systematically facilitate the evaluation and calibration methods described herein. However, embodiments are not limited to needing any uniform testing suite.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

The techniques described herein may be used for mobile device or client access to various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000. IS-95. IS-856 and High Rate Packet Data (HRPD) standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA is part of Universal Mobile Telecommunication System (UMTS). Long Term Evolution (LTE) is a radio access technology used by E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). IEEE 802.11 networks are also known as WiFi networks or wireless local area networks (WLANs) and are defined in a family of standards from the Institute of Electrical and Electronics Engineers (IEEE). These various radio technologies and standards are known in the art.

Various examples have been described. These and other examples are within the scope of the following claims.

What is claimed is:

1. A touchscreen system, comprising:
a touchscreen configured to receive touch data from a user;
a plurality of modules collectively configured to:
process the touch data;
display an output based on the processed touch data; and
a touch performance profiler module communicatively coupled to at least one of the plurality of modules and configured to:
monitor the at least one of the plurality of modules in real-time;
output performance attributes of the at least one of the plurality of modules based at least in part on the monitoring.

2. The touchscreen system of claim 1, wherein the output performance attributes comprise data indicative of scan-rate of the touchscreen, power consumption of the touchscreen system, latency of the touchscreen system, linearity error, stability, or accuracy of the touchscreen.

3. The touchscreen system of claim 1, wherein the touchscreen system is communicatively coupled to a display device configured to present the performance attributes to the user.

4. The touchscreen system of claim 1, wherein the touch performance profiler module resides within a kernel layer of an operating system.

5. The touchscreen system of claim 1, wherein the touch performance profiler module is further configured to:
analyze the performance attributes of the at least one of the plurality of modules based at least in part on the monitoring; and
output results of the analysis of the performance attributes, wherein the results are indicative of performance of the touchscreen system.

6. The touchscreen system of claim 1, wherein the output performance attributes comprise a pass or fail result for the at least one of the plurality of modules.

7. The touchscreen system of claim 1, wherein the touch performance profiler module is further configured to simulate one or more real-world variables that affect the performance attributes of the at least one of the plurality of modules.

8. The touchscreen system of claim 7, wherein the one or more real-world variables comprises at least one of heat, noise, moisture, or brightness.

9. A method for evaluating touch processing on a touchscreen system, the method comprising:
receiving touch data representative of a touch on a touchscreen;
monitoring the performances of a plurality of modules, wherein each module is configured to process the touch data; and
outputting performance data indicative of the performances of the plurality of modules.

10. The method of claim 9, wherein the output performance data comprises data indicative of scan-rate of the touchscreen, power consumption of the touchscreen system, latency of the touchscreen system, linearity error, stability, or accuracy of the touchscreen.

11. The method of claim 9, further comprising presenting, via a display device, the performance attributes to a user.

12. The method of claim 9, wherein the monitoring and outputting steps are performed by a touch performance profiler module that resides within a kernel layer of an operating system.

13. The method of claim 12, wherein the touch performance profiler module is further configured to:
analyze the performance data of the plurality of modules based at least in part on the monitoring; and
output results of the analysis of the performance data, wherein the results are indicative of performance of the touchscreen system.

14. The method of claim 12, wherein the touch performance profiler module is further configured to simulate one or more real-world variables that affect the performance data of at least one of the plurality of modules.

15. The method of claim 14, wherein the one or more real-world variables comprises at least one of heat, noise, moisture, or brightness.

16. The method of claim 9, wherein the output performance data comprises a pass or fail result for at least one of the plurality of modules.

17. An apparatus for evaluating touch processing on a touchscreen system, the apparatus comprising:
means for receiving touch data representative of a touch on a touchscreen;
means for monitoring the performances of a plurality of modules, wherein each module is configured to process the touch data; and
means for outputting performance data indicative of the performances of the plurality of modules.

18. The apparatus of claim 17, wherein the output performance data comprises data indicative of scan-rate of the touchscreen, power consumption of the touchscreen system, latency of the touchscreen system, linearity error, stability, or accuracy of the touchscreen.

19. The apparatus of claim 17, further comprising means for presenting, via a display device, the performance attributes to a user.

20. The apparatus of claim 17, wherein the monitoring and outputting steps are performed by a touch performance profiler module that resides within a kernel layer of an operating system.

21. The apparatus of claim 20, wherein the touch performance profiler module is further configured to:
analyze the performance data of the plurality of modules based at least in part on the monitoring; and
output results of the analysis of the performance data, wherein the results are indicative of performance of the touchscreen system.

22. The apparatus of claim 20, wherein the touch performance profiler module is further configured to simulate one or more real-world variables that affect the performance data of at least one of the plurality of modules.

23. The apparatus of claim 22, wherein the one or more real-world variables comprises at least one of heat, noise, moisture, or brightness.

24. A processor-readable non-transitory medium comprising processor readable instructions configured to cause a processor to:
receive touch data representative of a touch on a touchscreen of a touchscreen system;
monitor the performances of a plurality of modules, wherein each module is configured to process the touch data; and
output performance data indicative of the performances of the plurality of modules.

25. The processor-readable non-transitory medium of claim 24, wherein the output performance data comprises data indicative of scan-rate of the touchscreen, power consumption of the touchscreen system, latency of the touchscreen system, linearity error, stability, or accuracy of the touchscreen.

26. The processor-readable non-transitory medium of claim 24, further comprising presenting, via a display device, the performance attributes to a user.

27. The processor-readable non-transitory medium of claim 24, wherein the monitoring and outputting steps are performed by a touch performance profiler module that resides within a kernel layer of an operating system.

28. The processor-readable non-transitory medium of claim 27, wherein the touch performance profiler module is further configured to:
analyze the performance data of the plurality of modules based at least in part on the monitoring; and
output results of the analysis of the performance data, wherein the results are indicative of performance of the touchscreen system.

29. The processor-readable non-transitory medium of claim 27, wherein the touch performance profiler module is further configured to simulate one or more real-world variables that affect the performance data of at least one of the plurality of modules.

30. The processor-readable non-transitory medium of claim 29, wherein the one or more real-world variables comprises at least one of heat, noise, moisture, or brightness.
